(19) United States
(12) Patent Application Publication
(10) Pub. No.: US 2009/0208625 A1
(43) Pub. Date: Aug. 20, 2009

(54) FOOD CUTTING DEVICE

(76) Inventors: Christina Slevkoff, Irvine, CA (US); Ryan Whitney, Essex, VT (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/031,588

(22) Filed: Feb. 14, 2008

(51) Int. Cl. B26B 29/06; B26B 27/00; A47J 43/00; B26D 1/12

(52) U.S. Cl. 426/518; 99/537; 30/290

(57) ABSTRACT

A food cutting device can include a food drawer, a base, and a force application mechanism. The food drawer can have an upper plate and a lower plate that are hinged clamshell-style. The food drawer can be slid relative to the base to open and close the food drawer. The base can be adapted to mount under an existing kitchen component such that the food cutting device does not take additional counter space. The base can include a force application mechanism such as a roller mechanism disposed thereon and configured to compress the upper plate of the food drawer onto the lower plate as the drawer is closed. A cutting mechanism such as a cutting blade can be positioned on one of the plates of the food drawer such that when the food drawer is closed, the plates are compressed and the cutting mechanism is advanced into a food item in the drawer.

### BACKGROUND OF THE INVENTION

1. Field of the Invention

This application relates to a device for cutting food.

2. Description of the Related Art

Restaurants, particularly quick service restaurants, often serve food items that are cut for a customer's convenience. For example, food items such as sandwiches, pizza, and quesadillas are often cut by restaurant staff so that a customer can pick up individual pieces as finger food. It can be difficult to achieve consistently uniform results in the food cutting operation in the confines of a restaurant kitchen.

Cutting a food item by hand can require a relatively large cutting surface. Especially in a quick service restaurant kitchen where available counter space can be sparse, it can be difficult for a restaurant manager to set aside sufficient space for a dedicated cutting surface.

Moreover, cutting a food item by hand rarely leads to uniform results among the food items served. If a restaurant is seeking to have a consistently uniform cut pattern in its food items, it can be difficult to achieve with manual cut procedures as different food servers can cut the food items quite differently. There can be significant variations among one food server over the course of a shift, among different food servers at a single restaurant, as well as among different affiliated restaurants. Previously, marking templates, such as colored alignment stripes have been applied to cutting surfaces to provide a visual guide to food servers for cutting food items. However, in a busy food service environment, food servers often do not have sufficient time to carefully follow the guides, and significant variation can still occur.

### SUMMARY OF THE INVENTION

In various embodiments described in further detail herein, a food cutting device and method of cutting a food item are provided that overcome the previously-encountered shortcomings in cutting food items and have further advantages. In certain embodiments, the food cutting devices and methods described herein can provide efficient, quick, safe cutting of food items with uniformity in cutting among food items. Moreover, in certain embodiments, the food cutting devices described herein can be configured to be mounted under existing kitchen components, and thus can take little precious counter space in what may be a busy, crowded kitchen.

In certain embodiments, a food cutting device comprises a base, a food drawer, and a force application mechanism. The food drawer is slidably disposed relative to the base such that the drawer has an open configuration and a closed configuration relative to the base. The food drawer comprises a lower plate, an upper plate, and a cutting blade. The lower plate is configured to receive a food item. The upper plate is pivotally coupled to the lower plate such that the upper plate and the lower plate are pivotable relative to each other between a first position in which the upper plate and the lower plate are substantially parallel and a second position in which the upper plate and the lower plate are generally transverse relative to each other. The cutting blade is disposed on one of the lower plate and the upper plate. The force application mechanism is configured to move the upper plate, the lower plate, or both plates towards the first position as the drawer is slid into the closed configuration.

In other embodiments, a food cutting device comprises a base, a food drawer, a cutting mechanism, and a roller assembly. The food drawer has a lower surface configured to receive an item of food. The drawer has an extended configuration and a retracted configuration relative to the base. The cutting mechanism is movable between a first position in which the cutting mechanism is disposed away from the lower surface of the food drawer and a second position in which the cutting mechanism is adjacent the lower surface of the food drawer. The roller assembly is configured to advance the cutting mechanism from the first position to the second position as the drawer is slid from the open configuration to the closed configuration.

In still other embodiments, a method for cutting a food item is provided. The method comprises opening a drawer of a food cutting device, separating plates of the drawer, placing a food item in the drawer, moving the upper plate toward the lower plate, and sliding the drawer past a force application mechanism. The drawer of the food cutting device comprises an upper plate and a lower plate pivotally mounted in a clamshell arrangement and a cutting mechanism disposed on one of the upper plate and the lower plate. The plates are separated by separating the upper plate of the drawer from the lower plate of the drawer. The drawer is slid such that a force application mechanism compresses the upper plate and the lower plate relative to one another.

### BRIEF DESCRIPTION OF THE DRAWINGS

These and other features, aspects, and advantages of various embodiments the food cutting device will now be described in connection with one embodiment of the food cutting device shown in the accompanying drawings. The illustrated embodiment, however, is merely an example and is not intended to limit the invention. The drawings include the following ten figures.

FIG. 1 illustrates a perspective view of one embodiment of food cutting device with a food drawer in an open position;

FIG. 2 illustrates an exploded view of the food cutting device of FIG. 1;

FIG. 3 illustrates a bottom plan view of top plate of a clamshell assembly of the food drawer in the food cutting device of FIG. 1;

FIG. 4 illustrates a top plan view of a bottom plate of the clamshell assembly of the food drawer in the food cutting device of FIG. 1;

FIG. 5 illustrates a perspective view of the food cutting device of FIG. 1 in an open configuration disposed under a kitchen component;

FIG. 6 illustrates a perspective view of the food cutting device of FIG. 5 in a closed configuration;

FIG. 7 illustrates a cross-sectional side view of the food cutting device of FIG. 1 in an open position

FIG. 8 illustrates a cross-sectional side view of food cutting device of FIG. 1 in a partially-closed position;

FIG. 9 illustrates a cross-sectional side view of the food cutting device of FIG. 1 in a further closed position;

FIG. 10 illustrates a perspective view of the food cutting device of FIG. 1 in an open configuration with a cut food item inside.

### DETAILED DESCRIPTION OF THE PREFERRED EMBODIMENT

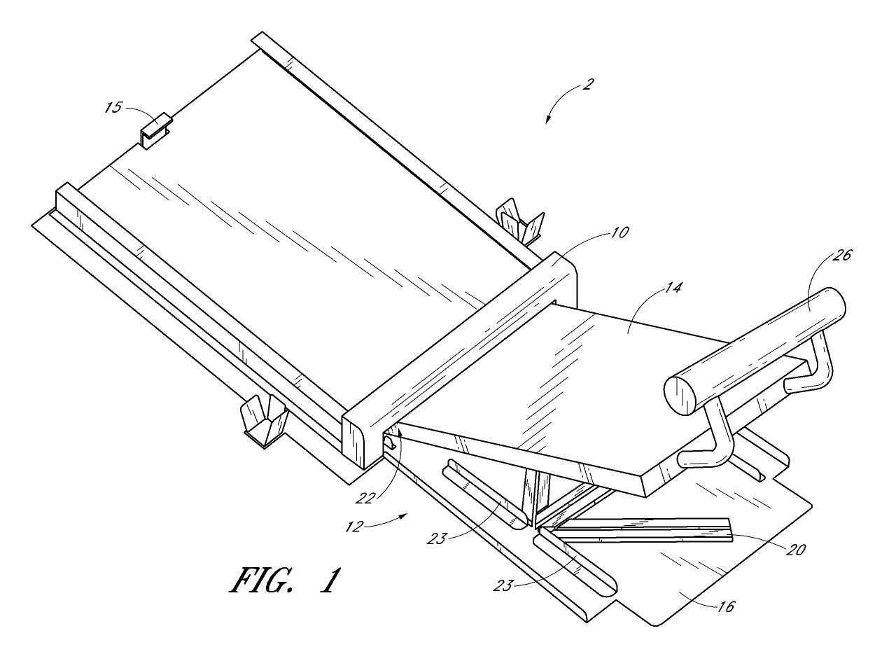

With reference to FIG. 1, a food cutting device 2 is illustrated in an open position. In the illustrated embodiment, the food cutting device 2 comprises a base 10, a food drawer 12, and a force application mechanism 22. In the illustrated embodiment, the food drawer 12 comprises an upper plate 14 and a lower plate 16 that are pivotally coupled about an edge thereof in a clamshell arrangement.

In the illustrated embodiment, the base 10 comprises an overhead mount such that the food cutting device 2 can be mounted under a kitchen component such as an oven, a cabinet, a refrigerator, or another kitchen appliance or storage device. Advantageously, this overhead mounting can allow the food cutting device 2 to be stored in a kitchen without taking valuable floor or counter space in a kitchen of a restaurant. In other embodiments, the base can be a countertop mount, allowing the food cutting device 2 to be mounted to the top surface of a counter. In other embodiments, the base can be a lateral mount to allow the food cutting device 2 to be mounted to a side wall of a cabinet or appliance.

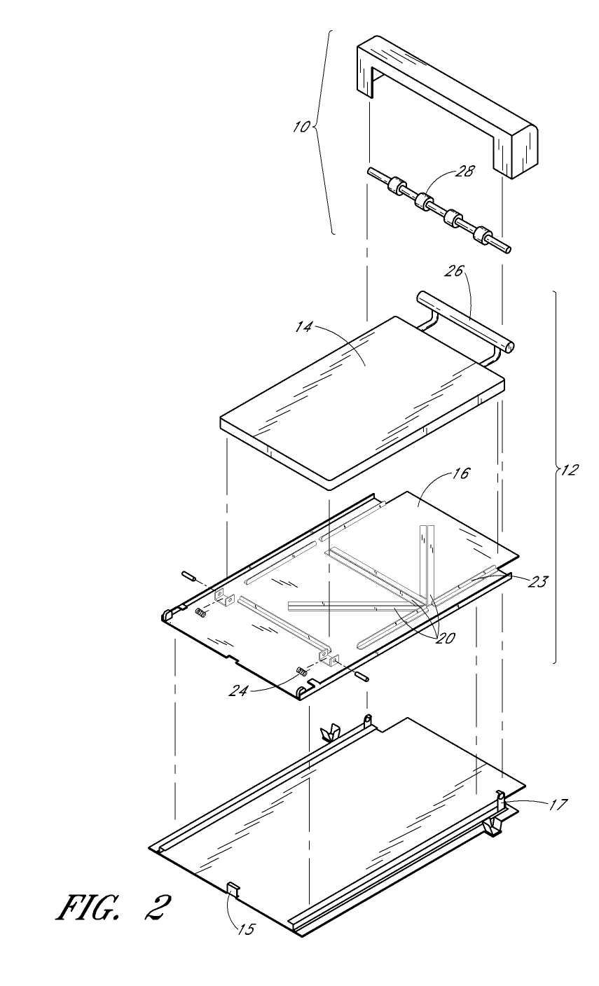

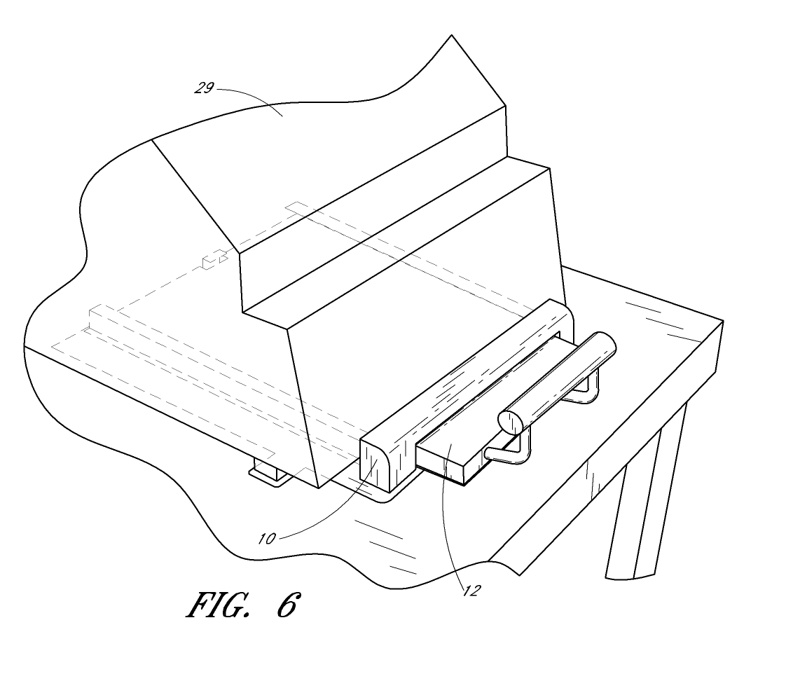

With reference to FIGS. 1 and 2, the food cutting device 2 can also include one or more feet 21. In the illustrated embodiment, the food cutting device includes two feet 21 on the base 10. Where the food cutting device 2 is mounted under a kitchen component, the feet 21 can contact a surface below the kitchen component, such as a countertop, appliance top, table, or other kitchen component (see, for example, FIG. 6). The feet 21, therefore, can provide additional stability for the food cutting device in operation. In some embodiments, each foot 21 can include a foot pad forming a lower surface thereof. In some embodiments, the foot pad can comprise a shock absorbent material, which can smoothen the operation of the food cutting device 2 and dampen any forces resulting from the operation of the food cutting device 2 that would otherwise be transmitted to the kitchen component or the surface below the kitchen component. In some embodiments, the foot pad can comprise a non-slip surface, which can be configured maintain the position of the food cutting device on a countertop, appliance top, table, or other kitchen component. For example, the non-slip surface of the foot pad can be comprised of a material having a relatively high coefficient of friction, or can include a surface texture such as a roughened or ridged surface texture configured to maintain the position of the food cutting device. In some embodiments, the foot pad can be configured of a material that is both shock absorbent and has non-slip properties. With reference to FIG. 1, the base 10 can include a guide defining the translation or sliding motion of the food drawer 12 relative to the base 10. In the illustrated embodiments, the guide of the base 10 defines a substantially linear translation or sliding motion. In other embodiments, the guide can define different drawer travel paths such as translation combined with pitch changes or translation combined with rotation.

With reference to FIGS. 1 and 2, the food drawer 12 is illustrated. The food drawer 12 comprises an upper plate 14 and a lower plate 16 pivotally coupled to one another. In the illustrated embodiment, the upper plate 14 and the lower plate 16 are pivotally connected along a rear edge of each of the plates 14, 16, thus forming a clamshell assembly. In other embodiments, the upper plate 14 and the lower plate 16 can be pivotally coupled in other arrangements. For example, in other embodiments, the upper plate 14 and the lower plate 16 can be pivotally coupled along ether edges than the rear edge thereof.

In the illustrated embodiments, the pivotal coupling between the upper plate 14 and the lower plate 16 defines a pivotal range of motion. As illustrated, the upper plate 14 and the lower plate 16 can be pivoted with respect to each other between a first position in which the upper plate 14 and the lower plate 16 are substantially parallel and a second position in which the upper plate 14 and the lower plate 16 are transverse to one another. The first position defines a closed configuration of the plates 14, 16. The second position of the plates 14, 16, which is illustrated in FIG. 1, defines an open configuration of the plates in which a food item can be placed therebetween.

In the illustrated embodiments, the food drawer 12 can have a handle 26 disposed on a front edge of the upper plate 14. A food server can slide the food drawer 12 relative to the base 10 using the handle 26. The food server can also use the handle 26 to open or close the upper plate 14 relative to the lower plate 16.

In the illustrated embodiments, the food drawer 12 and its associated upper and lower plates 14, 16, are configured to cut a relatively thin, substantially planar food item, such as a quesadilla. Thus, as illustrated, the plates 14, 16 can be relatively planar. In the closed configuration, the plates 14, 16 can be relatively close to one another. It is contemplated that in other embodiments, the food cutting device 2 described herein can be configured to cut other food items such as sandwiches, wraps, pizzas, cakes, pies, or other food items. In those embodiments, the plates 14, 16 can be non-planar and have different pivotal connections than that of the illustrated embodiment. For example, the pivotal connection between the plates could be configured to allow clearance between the plates 14, 16 in the closed configuration to allow a relatively thick sandwich, wrap, or burrito to be cut.

With continued reference to FIGS. 1 and 2, the food cutting device 2 can also include a force application mechanism 22. The force application mechanism 22 can be configured to pivot the upper plate 14 and the lower plate 16 towards the first position as the food drawer 12 is slid closed with respect to the base 10. As further discussed below, in some embodiments, the force application mechanism 22 can comprise a roller assembly 28 (FIG. 2).With respect to FIG. 2, an exploded perspective view of the food cutting device 2 of FIG. 1 is illustrated. In the illustrated embodiments, the slidable interface between the base 10 and the food drawer 12 can be seen. Additionally, the pivotal connection between the upper plate 14 and the lower plate 16 of the food drawer 12 can be seen. In the illustrated embodiment, the pivotal connection is shown as a pair of pinned hinges coupling the rear edges of the upper plate 14 and the lower plate 16 to one another in clamshell fashion. In other embodiments, the pivotal connection can be provided by more or fewer than two pinned hinge connections. In other embodiments, it is contemplated that other types of pivotal coupling mechanism can be used to couple the upper plate 14 to the lower plate 16.

In the illustrated embodiment, the pinned hinge connection is configured to bias the upper plate 14 away form the lower plate 16. This biasing can be provided by a biasing member. In the illustrated embodiment, the biasing member comprises a coil spring 24 that can be disposed about the pinned hinge. In other embodiments, the biasing member can comprise other components such as linear springs, torsion springs, tubular struts, or other devices. Advantageously, this biasing member facilitates lifting the upper plate when the food drawer 12 is slid open relative to the base 10.

In some embodiments, the biasing member can be configured to support the weight of the upper plate 14 when the drawer 12 is in the open configuration. Advantageously, this support can enhance operator safety as the upper plate 14 is unlikely to fall and catch a hand of a food service worker who is retrieving a cut food item from the drawer. In other embodiments, different support mechanisms that are not necessarily biasing members can be used in the food cutting device 2 to maintain the upper plate 14 in the open position. For example, various latches and ratchet mechanisms can be incorporated into various embodiments of the food drawer 12 to support the upper plate 14 in the open configuration.

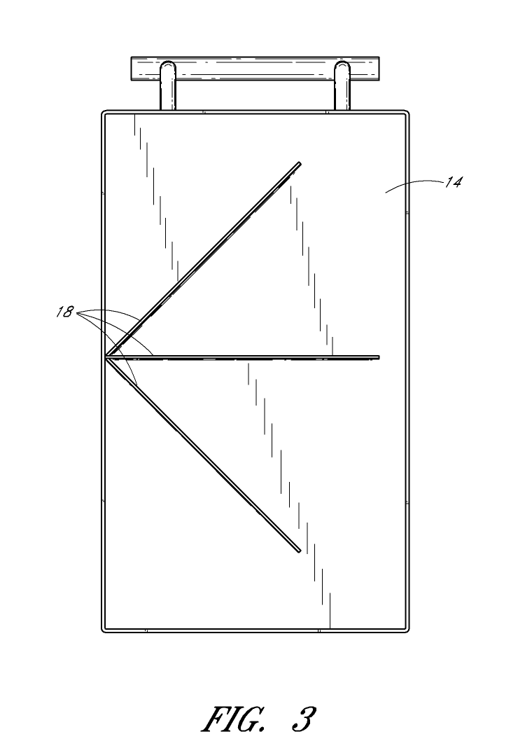

With respect to FIG. 3, one embodiment of upper plate 14 for use in a food drawer 12 in certain embodiments of food cutting device 2 is illustrated. A front view of the upper plate 14 is shown. In the illustrated embodiment, the upper plate 14 includes a cutting mechanism comprising three cutting blades 18. As illustrated, the three cutting blades 18 are arranged to cut a semi-circular quesadilla formed by folding a tortilla substantially in half to sandwich cheese, meat, vegetables, and/or another filler. In the illustrated embodiment, the cutting blades 18 are positioned with respect to each other to cut the semi-circular quesadilla into four substantially equal sized wedges.

With continued reference to FIG. 3, the cutting mechanism comprises a plurality of cutting blades 18 disposed on one of the plates 14, 16. In the illustrated embodiment, the cutting blades 18 are disposed on the upper plate 14. Advantageously, this positioning on the upper plate 14 can enhance user safety as a user will not need to reach around or over a cutting blade 18 when positioning and removing the food item in the food drawer 12. In other embodiments, the cutting mechanism, such as one or more cutting blades 18 can be disposed on the lower plate 16.

In other embodiments, the cutting mechanism can comprise more or fewer than three cutting blades 18. For example, it can be desirable, for example, where a quesadilla is offered as a pre-meal appetizer, rather than a main course, for the cutting mechanism to comprise more than three cutting blades 18 to cut a relatively large number of smaller wedges to promote sharing among several people. In other embodiments, the cutting mechanism can comprise only one or two blades, for example to halve a quesadilla.

Additionally, while the cutting mechanism of the illustrated embodiment is configured to cut a semi-circular food item into wedges, in some embodiments it can be desirable to cut a semi-circular food item into strips. Thus, in other embodiments, the cutting blades 18 could be substantially parallel to create multiple strips, rather than generally converging as the blades 18 of the illustrated embodiment.

Furthermore, while the cutting mechanism of the illustrated embodiment is configured to cut wedges from a semi-circular food item, in some embodiments, the cutting mechanism can be configured to cut other shapes of food item. For example, the cutting mechanism can be configured to cut wedges from a circular food item such as a quesadilla or a pizza, and the cutting mechanism can be configured to cut slices, wedges, or square segments from a generally square food item such as a sandwich.

In the illustrated embodiments, the cutting blades 18 can be honed edges of a strip such as a metallic strip. In other embodiments, the strip can be comprised of another material such as a plastic. In some embodiments, the cutting blades 18 can be serrated. In the illustrated embodiment, the cutting blades 18 are fixed with respect to the upper plate 14. In other embodiments, the cutting blades 18 can be configured to reciprocate, vibrate, or otherwise translate or oscillate with respect to the upper plate 14 to cut food.

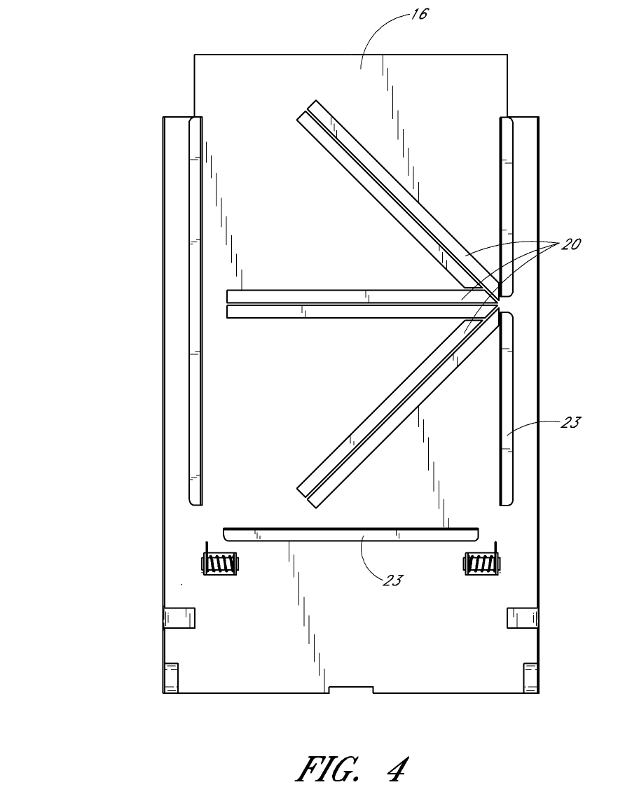

With reference to FIG. 4, a lower plate 16 of the food drawer 12 is illustrated. In some embodiments, the lower plate 16 can comprise at least one blade receiver. In some embodiments, the blade receiver comprises a groove 20 surrounded by two raised strips that is positioned and configured to receive a cutting blade 18 (FIG. 3) of the cutting mechanism when the plates 14, 16 of the food drawer 12 are in the closed configuration. In the illustrated embodiment, the lower plate 16 comprises three grooves, positioned such that each groove 20 is configured to receive a cutting blade 18 of the cutting mechanism positioned on the upper plate 14. In other embodiments, the blade receiver can likewise be configured to correspond to the cutting mechanism of the opposite plate. As noted above, the cutting mechanism can be positioned on either the upper or lower plates 14, 16. The blade receiver can be positioned on the opposite plate.

With continued reference to FIG. 4, the lower plate 16 can have one or more positioners 23. The positioners 23 are positioned and oriented on the lower plate 16 to provide a guide for placement of a food item. In the illustrated embodiment, the positioners 23 are configured to guide the placement of a semicircular quesadilla. In other embodiments, positioners can be configured and arranged to guide placement of other food items. Other embodiments of food cutting device do not have positioners. In some embodiments, fixed locations of the positioners 23 and the cutting mechanism provide uniformity among cut food items. Advantageously, then, a restaurant can offer consistent presentation of its food products regardless of which member of food service staff cuts the food item.

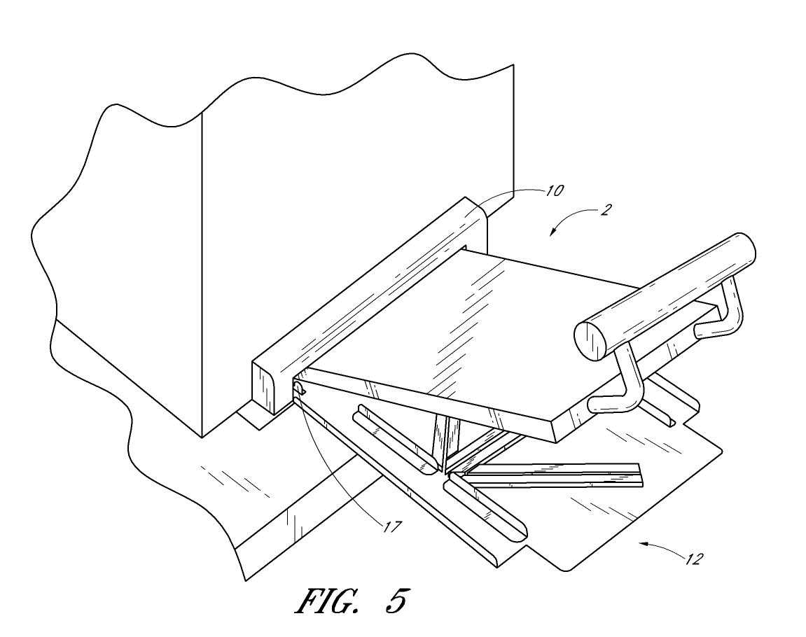

With reference to FIGS. 5 and 6, an embodiment of food cutting device 2 is schematically illustrated as positioned under a kitchen component 29. One advantage of the food cutting device 2 is that in various embodiments, the device can have a low profile configuration, for example, having a relatively small height such that it can be mounted under a kitchen component. In home and restaurant kitchens, counter space and cupboard space is often at a premium. Kitchen tools that occupy a relatively large amount of counter or cupboard space can be undesirable. In some embodiments, the base 10 can be configured such that the cutting device can be mounted under a kitchen component 29 such as a microwave, oven, refrigerator, cupboard, countertop, or other component. Advantageously, an undermounted food cutting device 2 can take relatively little additional kitchen space. As noted above, in other embodiments, the base 10 can be configured such that the cutting device can be mounted on top of a counter or component. In still other embodiments, the base 10 can be configured such that the cutting device can be removably placed atop a kitchen component.

FIG. 5 illustrates the food cutting device 2 in an open configuration such that a food item can be inserted into or removed from the food drawer 12. FIG. 6 illustrates the food cutting device 2 in a closed configuration. As depicted, when the food cutting device is in the closed configuration, it occupies relatively little counter space.

In some embodiments, the cutting device 2 can have stops to define the limits of travel of the food drawer 12 with respect to the base 10. For example, the base 10 can comprise a protrusion such as a stop 15 at an end thereof. The stop 15 can be configured to interfere with continued movement of the food drawer 12 with respect to the base 10 past a closed position (shown in FIG. 6). The base 10 can also comprise a latch mechanism 17 to selectively allow the food drawer 12 to be removed from the base 10. For example, it can be desirable to remove the food drawer 12 for cleaning or maintenance. Undisturbed, the latch mechanism 17 can define an opened configuration of the food drawer, impeding further movement of the drawer 12. When desired, however, an operator can unlatch the latch mechanism 17, such as by depressing, rotating, or otherwise moving the mechanism, to allow the food drawer 12 to be removed from the base 10.

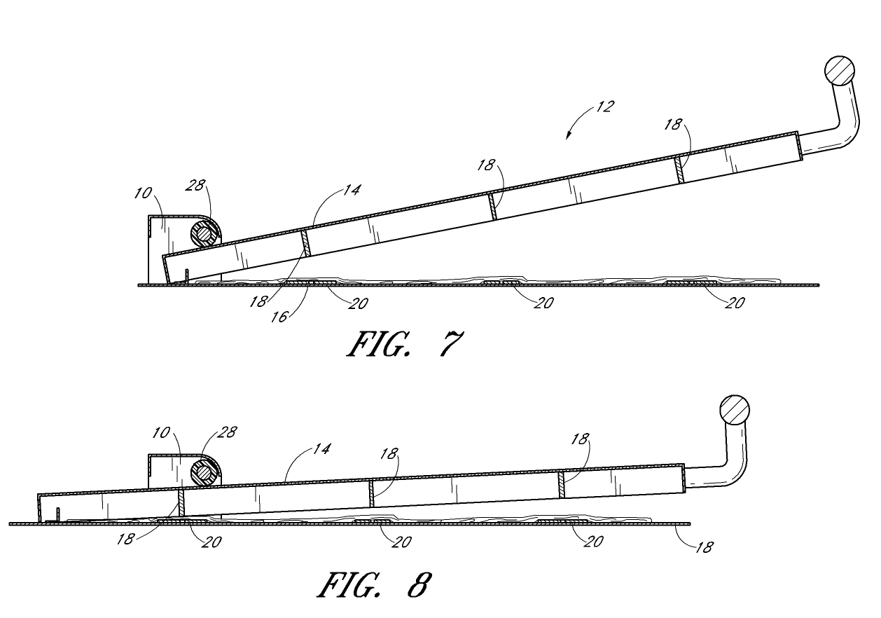

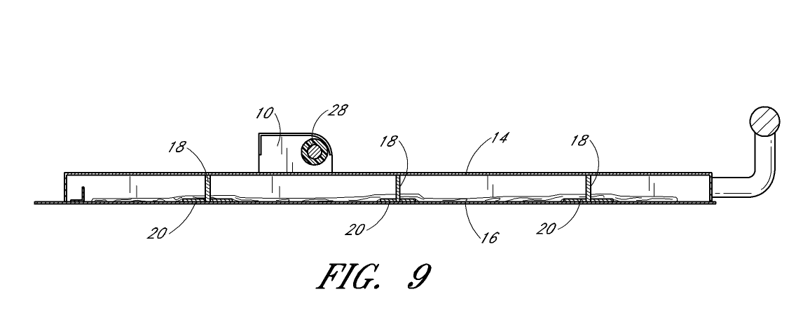

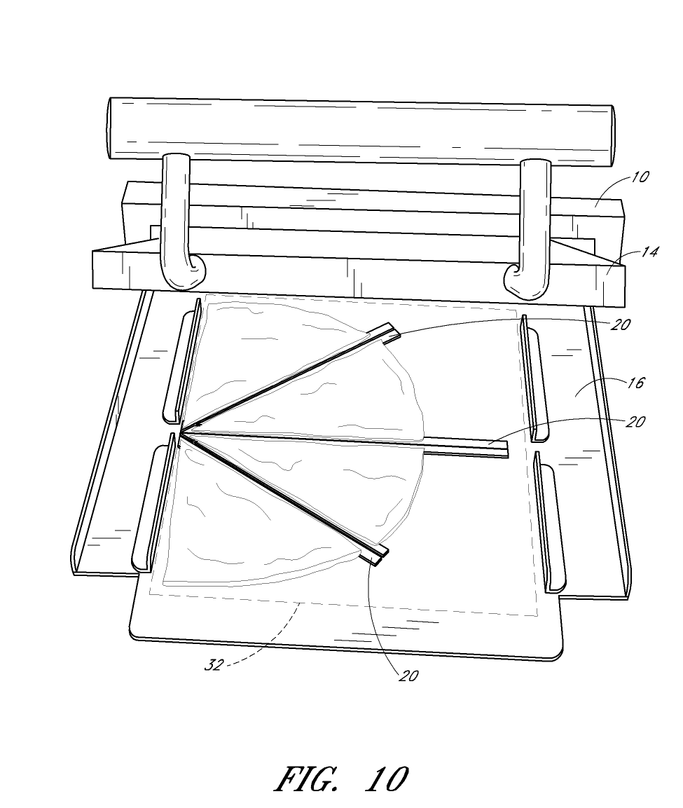

With reference to FIGS. 7-10 a food cutting sequence using the food cutting device 2 is illustrated. FIG. 7 illustrates the food cutting device 2 in an open configuration at the beginning of the food cutting sequence. FIG. 8 illustrates the food cutting device 2 in a partially closed configuration in part way through the food cutting sequence. FIG. 9 illustrates the food cutting sequence with the food cutting device 2 in a further closed configuration. FIG. 10 illustrates the food cutting sequence with the food cutting device 2 opened after the food has been cut.

As illustrated in FIG. 7, the food cutting device 2 is in an open configuration. The food drawer 12 is slid outward with respect to the base 10. As illustrated, the upper plate 14 is open with respect to the lower plate 16. With the food drawer 12 slid open and the plates 14, 16 open, a food item can be placed on the lower plate 16. As discussed above, in the illustrated embodiment, the food drawer 12 is configured to receive a substantially planar food item such as a quesadilla.

As illustrated in FIG. 8, the food cutting device 2 is in a partially closed configuration. The food drawer 12 is partially slid inward with respect to the base. As the food drawer 12 is slid inward to a closed position, the force application mechanism 22 applies force to compress the upper plate 14 and the lower plate 16 of the food drawer. In the illustrated embodiment, the force application mechanism 22 comprises a roller assembly 28 rotatably coupled to the base 10 and positioned so as to roll against an outer surface of the upper plate 14 when the drawer 12 is slid into the closed position. Thus, in the illustrated embodiments, the action of the roller assembly 28 on the outer surface of the upper plate 14 compresses the upper plate 14 into the lower plate 16 to close the clamshell drawer. This compression can cause the cutting blades 18 of to cut through the food item. In the illustrated embodiment, the outer surface of the upper plate 14 comprises a substantially level surface. In other embodiments, the outer surface of the upper plate 14 can comprise an inclined surface, wedge-shaped surface, or contoured surface or curved surface such that as the drawer slides closed, the force application mechanism applies an increasing amount of compressive force on the upper plate 14 to compress the upper and lower plates 14, 16.

In other embodiments, the force application mechanism 22 can be positioned to apply compressive force against an outer surface of the lower plate 16. For example, the force application mechanism 22 can comprise a roller assembly positioned at a lower surface of the lower plate 16 to compress the lower plate 16 into the upper plate 14 as the drawer is slid closed. In other embodiments, the force application mechanism 22 can comprise other mechanisms besides a roller. For example, in some embodiments, the force application mechanism 22 can be a spring-biased compression member, a skid, or another force applicator.

As illustrated in FIG. 9, the food drawer 12 has been slid into a further closed position with respect to the base 10. In the illustrated configuration, the force application mechanism 22 has compressed the upper plate 14 onto the lower plate 16. Thus, in the illustrated embodiment of food cutting device 2, the cutting blade 18 on the upper plate 14 has been advanced through the food item and into the recess 20 on the lower plate 16.

FIG. 10 illustrates the food cutting device 2 after completion of the food cutting/drawer closing cycle depicted in FIGS. 7-9 has been performed. In FIG. 10, the food drawer 12 has been slid out of the base 10 and the upper plate 14 has been opened away from the lower plate 16 of the food drawer. A food item can be seen in resting on the lower plate 16. As noted above, the food item illustrated herein comprises a quesadilla. As illustrated, the quesadilla has been cut in to four wedges by the three cutting blades 18. As discussed above, in other embodiments of food cutting device, the cutting blades 18 can have different orientations and configurations to create different cut patterns in the food item.

In the illustrated embodiment, the food item is under a protective sheet such as a food bag (illustrated in broken lines) 32. Food bags 32 capable of withstanding the cutting blades 18 of the food cutting device 2 can advantageously enhance the cleanliness and speed of cutting. Once the food item has been placed in a food bag 32, it can be cut and handled without leaving food particles and other debris on the cutting blades 18 and/or on the hands of the food preparer, which must later be cleaned or pose a cleanliness issue.

Although the food cutting device has been disclosed in the context of certain preferred embodiments and examples, it will be understood by those skilled in the art that the present disclosure extends beyond the specifically disclosed embodiments to other alternative embodiments and/or uses of the food cutting device and obvious modifications and equivalents thereof. In addition, while a number of variations of the food cutting device have been shown and described in detail, other modifications, which are within the scope of the inventions, will be readily apparent to those of skill in the art based upon this disclosure. It is also contemplated that various combinations or sub-combinations of the specific features and aspects of the embodiments may be made and still fall within the scope of the disclosure. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above, but rather should be defined by a fair reading of the claims that follow.

What is claimed is:

1. A food cutting device comprising:
a base;
a food drawer slidably disposed relative to the base such that the drawer has an open configuration and a closed configuration relative to the base, the drawer comprising:
a lower plate configured to receive a food item;
an upper plate pivotally coupled to the lower plate such that the upper plate and the lower plate are pivotable relative to each other between a first position in which the upper plate and the lower plate are substantially parallel and a second position in which the upper plate and the lower plate are generally transverse relative to each other; and
a cutting blade disposed on one of the lower plate and the upper plate; and
a force application mechanism configured to move the upper plate and the lower plate towards the first position as the drawer is slid into the closed configuration.

2. The food cutting device of claim 1, wherein the cutting blade is disposed on the upper plate.

3. The food cutting device of claim 2, wherein the lower plate comprises a groove formed therein and positioned to underlie the cutting blade when the upper plate and the lower plate are in the first position.

4. The food cutting device of claim 1, further comprising at least one additional cutting blade disposed on one of the upper plate and the lower plate.

5. The food cutting device of claim 4, wherein the cutting blades are disposed on the upper plate.

6. The food cutting device of claim 5, wherein the lower plate comprises a plurality of grooves formed therein and positioned to underlie the cutting blades when the upper plate and the lower plate are in the first position.

7. The food cutting device of claim 1, wherein the force application mechanism comprises a roller assembly.

8. The food cutting device of claim 7, wherein the roller assembly is fixed relative to the base.

9. The food cutting device of claim 8, wherein the roller assembly is arranged to apply a force to an upper surface of the upper plate as the drawer is slid towards the closed configuration.

10. A food cutting device comprising:
a base;
a food drawer having a lower surface configured to receive an item of food, the drawer having an open configuration and a closed configuration relative to the base;
a cutting mechanism movable between a first position in which the cutting mechanism is disposed away from the lower surface of the food drawer and a second position in which the cutting mechanism is adjacent the lower surface of the food drawer; and
a roller assembly configured to advance the cutting mechanism from the first position to the second position as the drawer is slid from the open configuration to the closed configuration.

11. The food cutting device of claim 9, wherein the drawer has a low profile configuration.

12. The food cutting device of claim 9, wherein the drawer comprises a lower plate and an upper plate pivotally connected to one another in a clamshell arrangement.

13. The food cutting device of claim 9, wherein the base further comprises a foot.

14. The food cutting device of claim 13, wherein the foot comprises a foot pad composed of a non-slip material.

15. The food cutting device of claim 9, wherein the cutting mechanism comprises three blades.

16. The food cutting device of claim 9, wherein the food drawer comprises a groove sized and configured to receive the cutting mechanism when the cutting mechanism is advanced into the second position.

17. A method for cutting a food item comprising:
opening a drawer of a food cutting device comprising: an upper plate and a lower plate pivotally mounted in a clamshell arrangement, and a cutting mechanism disposed on one of the upper plate and the lower plate;
separating the upper plate of the drawer from the lower plate of the drawer;
placing the food item in the drawer;
moving the upper plate toward the lower plate; and
sliding the drawer past a force application mechanism that compresses the upper plate and the lower plate relative to one another.

18. The method of claim 17, wherein sliding the drawer past a force application mechanism comprises sliding the drawer past a roller assembly.

19. The method of claim 18, wherein sliding the drawer past a roller assembly comprises rolling the roller assembly against an outer surface of the upper plate to apply a force to the upper plate.

20. The method of claim 17, wherein sliding the drawer comprises sliding the drawer out from under a kitchen component.
